(19) United States
(12) Patent Application Publication
(10) Pub. No.: US 2005/0157730 A1
(43) Pub. Date: Jul. 21, 2005

(54) Configuration management for transparent gateways in heterogeneous storage networks

(76) Inventors: Robert Hale Grant, Toronto (CA); Henry Yang, Erie, CO (US); Ernest Dainow, Toronto (CA); Xai Phan, Toronto (CA)

Correspondence Address: HOGAN & HARTSON LLP, ONE TABOR CENTER, SUITE 1500, 1200 SEVENTEENTH ST, DENVER, CO, 80202, US

(21) Appl. No.: 10/699,577

(22) Filed: Oct. 31, 2003

(51) Int. Cl. H04L 12/28

(52) U.S. Cl. 370/401

(57) ABSTRACT

A gateway having a first port coupled to a first network and a second port coupled to a second network. Processes are implemented within the gateway for identifying at least one service provided by the first network that is not provided by the second network. Processes are also implemented within the gateway for implementing the at least one service on behalf of the second network.

### BACKGROUND OF THE INVENTION

1. Field of the Invention

The present invention relates, in general, to configuring network devices, and, more particularly, to software, systems and methods for configuring transparent gateway devices in heterogeneous storage networks.

2. Relevant Background.

A heterogeneous network is one that comprises multiple networks, sometimes referred to as subnets, having different, often incompatible, requirements and capabilities. Each network supports connections to devices such as host computers, storage resources, and the like which are coupled to end-nodes of the networks. Each network often has its own independent address space, naming conventions, and uses data packet formats and protocols that are recognized on that network, but are invalid on other networks. These disparate networks may be joined by a gateway device that maps communication from one network to a format and address space compatible with a second network.

While it is almost always easier to use a single network type and protocol, this is often not practical. Heterogeneous storage networks are particularly common because once large quantities of data are stored in a storage area network (SAN) based on a particular protocol, it is laborious to migrate data to a new SAN with a new protocol. As new business applications develop, or business entities merge, it is desirable to manage data across heterogeneous storage area networks to allow data storage facilities on disparate SANs to communicate with each other and with host computers coupled to each.

Fibre Channel (FC) SANs have been widely used in recent years due to their high speed and high reliability. FC SANs use protocols published as standards by the American National Standards Institute (ANSI), to communicate data traffic with storage devices over a switched communication topology referred to as a “fabric”. Fibre Channel fabrics tend to support very high bandwidth communication desirable for communication between hosts and storage facilities. Moreover, Fibre Channel standards define standards that enable the transport of other protocols such as Internet Protocol (IP) and small computer system interface (SCSI) protocol communications over a Fibre Channel transport. Because mass storage devices frequently use SCSI interfaces, Fibre Channel became a very popular choice for SAN implementations.

More recently, Internet Protocol (IP) based storage networks have become available using protocols and standards developed by the Internet Engineering Task Force (IETF). RFC3347 defines an “Internet SCSI” (iSCSI) protocol that describes a means of transporting SCSI data packets over Transmission Control Protocol/Internet Protocol (TCP/IP) connections, providing for an interoperable solution which can take advantage of existing Internet infrastructure and Internet management facilities. By carrying SCSI commands over IP networks, iSCSI is used to facilitate data transfers over intranets and to manage storage over long distances. The iSCSI protocol is expected to help bring about rapid development of the storage area network (SAN) market, by increasing the capabilities and performance of storage data transmission.

Although Fiber Channel communication protocols define robust and adaptable data communication networks for both local area network (LAN) and wide area network (WAN) usage, Fiber Channel is not widely accepted for general LAN applications, although it remains a leading technology for SAN implementations. LANs most frequently involve TCP/IP networks, the protocol used by the Internet. Because of the ubiquity of IP networks, iSCSI can be used to transmit data over a large installed base of local area networks (LANs), wide area networks (WANs), or the Internet and can enable location-independent data storage and retrieval. As a result, there is an increasing need for FC-to-IP gateway devices that connect an iSCSI Storage Area Network to FC Storage Area Networks and, more generally, to connect FC fabrics to IP networks.

However, the manner in which the SCSI protocol is mapped onto a Fibre Channel transport differs from the manner in which iSCSI maps SCSI onto TCP/IP transport. For example, iSCSI defines constructs such as command ordering, iSCSI login, text negotiation, iSCSI protocol data units, and iSCSI naming. In contrast, the fibre channel IP interoperability standard (FC-IP) calls for many of the SCSI-compliant aspects to be handled by other aspects of the Fibre Channel transport. In this regard, iSCSI is useful primarily for supporting SCSI on homogeneous IP networks, and does not define functionality and behavior of an iSCSI-to-FCP gateway. Likewise, FC-IP does not define functionality and behavior for interoperating with iSCSI directly.

More generally, when a gateway device is used to coupled heterogeneous networks, there is important information on each side of the gateway about the devices, gateway session, and network that must be set up correctly to provide transparent mapping and automatic gateway sessions. This information includes, for example, device name(s), addresses, zone information, virtual LAN (VLAN) information, IP network information, security associations (e.g., authentication, access control, security passwords/keys, etc.), network addresses, link addresses, and the like. Similarly, a network on one side of a gateway may offer services that are not available on a network coupled to another side of the gateway. In such circumstances, it is difficult or impossible for devices that use these services to communicate transparently with each other.

For example, a device on an IP network may be a member of a domain defined within that IP network, but which has no meaning on a gateway-coupled FC network. Although the IP device may be able to address devices on the FC network, critical information associated with the IP device's domain membership is not shared across the gateway, which may prevent or complicate communications between the IP device and FC network resources. In other words, it is not sufficient to simply map addressees between disparate networks through a gateway. Instead, a need exists for more complete gateway services that map network-specific information and services between multiple joined networks.

The term “transparent gateway” refers to a gateway device that preserves identity of end-nodes in one network and maps them to appropriate names in the other network(s). This involves configuring the gateway device using a network management application to allow the gateway to automatically set up gateway sessions as devices come on line and attempt to communicate through the gateway. Current techniques involve manually configuring the gateway device with the necessary information to provide this mapping. Once properly configured, a gateway is transparent to the end devices. However, the configuration process can be cumbersome to the network administrator tasked with performing the configuration. Moreover, as devices are added to, modified, and/or removed from any of the networks, the gateway must be manually reconfigured to reflect the changes.

### SUMMARY OF THE INVENTION

Briefly stated, the present invention involves a gateway having a first port coupled to a first network and a second port coupled to a second network. Processes are implemented within the gateway for identifying at least one service provided by the first network that is not provided by the second network. Processes are also implemented within the gateway for implementing the at least one service on behalf of the second network.

In another aspect, the present invention involves a method for configuring a heterogeneous network including providing a gateway having a first port coupled to a first network and a second port coupled to a second network. The gateway identifies at least one service provided by the first network that is not provided by the second network. The gateway implements the at least one service on behalf of the second network while the second network is unable to implement that service.

In another aspect, the present invention involves a gateway for joining incompatible networks in which the gateway identifies at least one device on each of the incompatible networks. The gateway creates a virtual representation of each of the identified devices and creates a connection between the virtual representation and the at least one identified device that is being represented. A connection is created between the virtual representations to implement a functional connection between the identified devices.

### BRIEF DESCRIPTION OF THE DRAWINGS

FIG. 1 shows a networked computer environment in which the present invention is implemented;

FIG. 2 shows a simplified storage area network (SAN) environment in which the present invention is implemented;

FIG. 3 illustrates, in flow-diagram form, several processes involved in establishing a communication channel in accordance with the present invention; and

FIG. 4 shows a FC-iSCSI Gateway Datapath Model in accordance with the present invention.

### DETAILED DESCRIPTION OF THE PREFERRED EMBODIMENTS

The present invention involves a system and method that enables a transparent storage gateway to be administered either in conjunction with or instead of a SAN service provided by a SAN attached to the gateway. The present invention expands on traditional gateway configurations that simply pair end-nodes of disparate networks to form “gateway portals”. The present invention defines groups of these gateway portals, called gateway portal groups, by wild-carding parameters in the configuration. Configuration is then applied to the entire gateway portal group. This wild-carding and configuration of gateway portal groups then allows a transition between direct gateway configuration and using the SAN services of the networks attached to the gateway.

The present invention is illustrated and described in terms of a gateway joining disparate storage area networks (SANs), although the present invention is readily adapted to LAN and WAN networks/fabrics that perform functions beyond storage. The specific examples involve a gateway that joins Fibre Channel SCSI (FCP) SANs to Internet SCSI (iSCSI) SANs, although other SAN environment mapping is contemplated. More generally, the present invention is applicable to any Fibre Channel (FC) to Internet Protocol (IP) gateway and more generally still, the present invention is readily adapted to provide a transparent gateway between any two disparate networks.

Features of the present invention are useful even when two similar networks are joined by a gateway when those two networks offer a disparate set of services. For example, the present invention can implement a gateway between two IP networks in which only one network offers a device naming service. Because the two networks offer different services and resources, their combination is a heterogeneous network in accordance with the present invention.

The present invention is also directed to systems, methods and software for configuring the gateway itself. A configuration method appropriate for the transparent gateway must adapt to the changing environment of the heterogeneous SAN. Because each network in a heterogeneous SAN will develop independently, services and features often are available in one network that are unavailable in another network. Because of this, a need for a new feature (e.g., an authentication service) might exist before a SAN service is available for that feature in one or more of the SAN transports. Initially, the transparent gateway configuration in accordance with the present invention allows such a feature to be provided by the gateway. Once a SAN service is available in one or more of the transports (e.g., networks), however, the gateway configuration should allow use of the services provided by the SAN itself.

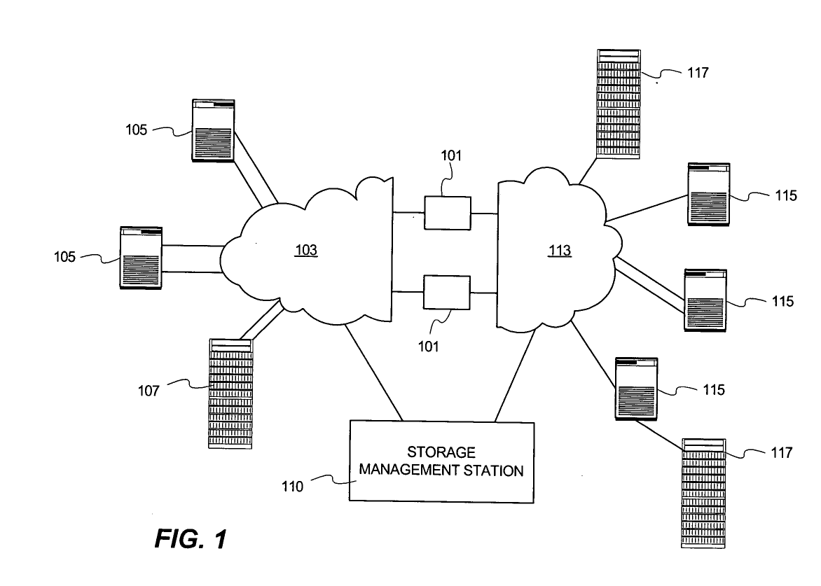

FIG. 1 shows a simple heterogeneous network formed by a Fibre Channel fabric 103 and an Internet Protocol network 113 joined by an gateway 101 in accordance with the present invention. One feature of gateway 101 in accordance with the present invention is that it allows end-nodes (hosts 105/115 and storage 107/117) from any network/fabric 103/113 to access end-nodes on the other network/fabric 103/113. The present invention enables data centers and enterprises with both Fibre Channel and iSCSI SANs to connect and administer those SANs 103 and 113 as seamlessly as possible. In FIG. 1, end-nodes of fabric 103 are commentated to devices such as hosts 105 and storage array 107. Similarly, end-nodes of network 113 are connected to devices such as hosts 115 and storage array 117. Hosts 105/115 often include multiple host bus adaptors (HBAs) to provide duplicative and/or redundant network connections to improve availability and/or performance. In a practical application, a large number of devices, in the order of tens, hundreds, thousands, or more, may be connected to each network 103/113 depending on the complexity and size of that network. In the case of a SCSI-based SAN, devices 105, 107, 115 and 117 view each other as SCSI initiators and targets and are desirably unaware of the details associated with their interconnection.

In operation, host devices 105/115 act as SCSI initiators and the storage devices 107/117 act as SCSI targets. Storage devices 107/117 may be coupled to an HBA of a host device 105/115, or may be coupled directly to the networks 103/113 as shown in FIG. 1. Currently, FC fabrics 103 are the dominate fabric for attaching storage devices 107, although there is an emerging and growing use of IP networks 113, using iSCSI mechanisms, to implement attached storage 117. One or more FC-iSCSI gateways 101 in accordance with the present invention join the disparate networks 103/113 to enable consistent access between hosts and storage devices on both networks.

Gateways 101 allow an initiator or target on one fabric to create an “I_T_nexus” with a far-end device on a different fabric. An I_T_nexus is a term defined by the SCSI standards to mean a relationship between a SCSI initiator port and a SCSI target port. To do this, gateway 101 creates a representation of that far-end device on the initiator or target's native fabric/network. This representation, referred to as a “virtual device”, has all the characteristics of a native SCSI device, but sends the SCSI commands and responses to the far-end device.

Gateway 101 desirably allows administration from via any fabric 103/113 through processes executing on selected hosts 105/115 and/or other network connected computer executing administrative and management processes such as storage management station 110. This may include allowing administration from multiple fabrics/networks simultaneously. For example, one might desire a coarse level management from the FC fabric (e.g., all hosts on the iSCSI fabric can access this FC storage) and a finer level on the iSCSI fabric (specifying particular iSCSI hosts can access this FC storage). Also, gateway 101 may allow the selection of SAN technology (i.e. FC or iSCSI) that best suits the needs of a particular SAN while allowing administration to extend across the SANs. Attributes that may favor FC or iSCSI in particular SAN environments include distance, security, sharing of network infrastructure, throughput, level of integration, legacy equipment and vendor support.

It may be desirable to allow administration across SANs to be controlled by different organizations. For example, a storage service provider could allow individual-level access control to a FC SAN through FC-iSCSI gateways whereas a data center would allow department level access control to its FC SAN through FC-iSCSI gateways.

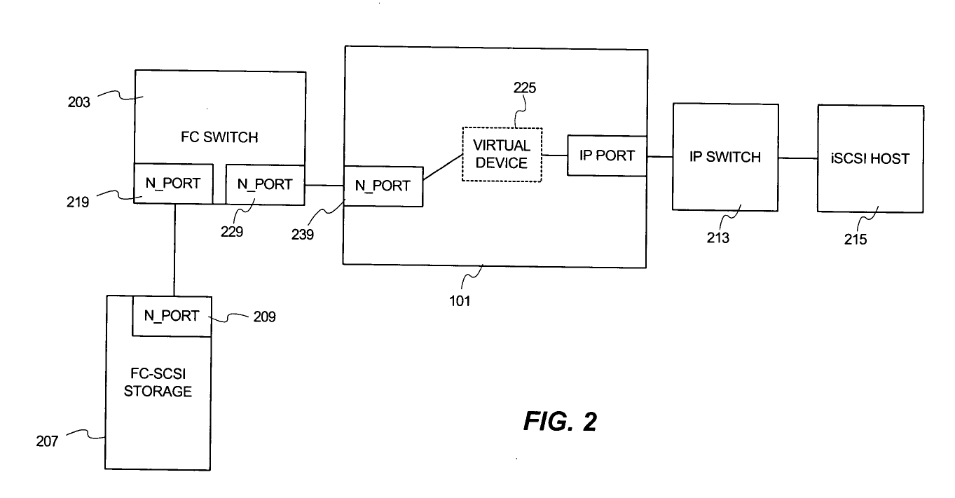

FIG. 2 illustrates a particular operational example involving a FC-native SCSI storage device 207 communicating with an iSCSI host 215. FC-native SCSI storage device 207 attaches to FC fabric 203, implemented by one or more FC switches, through a N-Port 209 on storage device 207 and an N-Port 219 on the FC fabric 103. Another N-Port 229 on fabric 203 couples to N-Port 239 on gateway 101. Gateway 101 creates a virtual device 225 attached through N-Port 239 to represent the iSCSI Host 115. It should be noted that a single virtual device 225 may attach through a single N-Port 239.

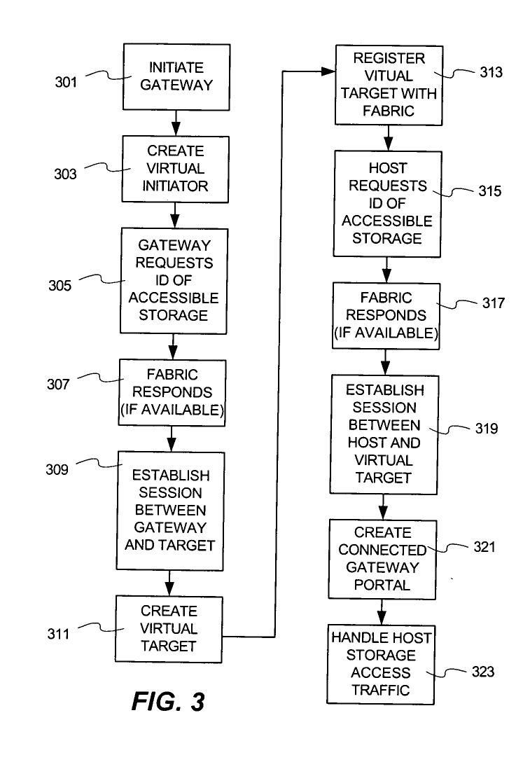

FIG. 3 illustrates in flow-diagram form various processes involved in establishing communication between a host 215 on an iSCSI network 213 and a storage device 207 on a FC network 203 as illustrated in FIG. 2. In the example, gateway 101 has been pre-configured (before being powered up) to represent an initiator (e.g., iSCSI host 215) onto FC fabric 203. Other scenarios are also supported, such as a “plug-and-play” implementation where there is no pre-configuration (i.e., all targets and initiators must be discovered after power up) or where gateway 101 has been pre-configured to represent a target (e.g., FC-SCSI storage device 207).

After the system initialization in 310, gateway 101 creates a virtual FC initiators, in 303 to represent the iSCSI host 215 based on stored configuration information describing the iSCSI host 215. The virtual initiator created in 303 is essentially a logical object comprising data structures and/or executable methods that define a set of resources allocated to virtual initiator. For simplicity, the examples assume that gateway 101 is configured to have some knowledge about targets and/or initiators, although this is not required. Alternatively, discovery processes may be used to enable a gateway 101 to determine this information after initialization step 101.

In operation 305, gateway 101 attempts to determine which storage devices are known to the fabric to be accessible by the virtual initiator created in 303. Fibre channel fabrics typically include services to support this type of discover, in which case the accessible storage devices will be registered with the fabric itself. The fabric service, if available, responds in 307 to the inquiry of step 305 with information identifying the available storage, including information needed to communicate with and connect to the available storage. It is contemplated that this type of service may be unavailable in some cases, however, in which case the gateway may be pre-configured with information about the available storage devices.

In 309, the gateway establishes a communication session (i.e., a group of TCP connections that link an initiator and a target) between the virtual initiator and the target device (e.g., FC-SCSI storage device 207). Gateway 101 then creates, in step 311, one or more virtual target(s) comprising, for example, a logical object representing each accessible target device. This virtual target device is registered with the iSCSI network 213 in operation 313 if the iSCSI network supports appropriate services. This gives the iSCSI network specific knowledge of the resources and connection information necessary to make connections to the target device through the virtual target implemented by gateway 101. At this stage, from the perspective of gateway 101 only the FC side of the connection set-up.

Typically, gateway 101 will wait for an iSCSI initiator before setting up the iSCSI half of the connection by issuing a SCSI connection request in 315. When a host logs in to the iSCSI network (e.g., IP switch 215), it may request the identity of accessible storage when such discovery services are available. The IP switch 215 will respond, if able, with an identification of virtual target devices that were registered in operation 313. In response to a SCSI connection request, gateway 101 creates a virtual establishes a session between the requesting host and the virtual target in operation 321.

At this point, two sessions exist, a first session between the virtual initiator and the target device, and a second session between the host and the virtual initiator. The gateway then creates a “connected gateway portal” by binding these two sessions. The host (initiator) and storage device (target) can then conduct storage access transactions according to established SCSI protocols and techniques as indicated at 323.

It should be noted that the “fabric service” or “network service” is not always part of the fabric/network. Specifically, IP networks tend to define far fewer services than Fibre Channel fabrics, and registration/discovery services may be available on the fibre channel side that have no counterpart on the IP side of the gateway. The Internet engineering task force (IETF) is currently considering several proposals to define services such as Internet Storage Name Service (iSNS), Service Location Protocol version 2 (SLPv2), IP Security (IPSec) and ISCSI Discovery Sessions that parallel several of the fabric services offered to end-nodes in Fibre channel. One feature of the present invention is that in instances where a particular service is unavailable in one of the networks, gateway 101 can implement a suitable version of that service until such time that the service becomes available in the network.

Moreover, the order of events may vary from that described in reference to FIG. 3, depending on what is pre-configured and what is discovered. An example of where the order might be different is when gateway 101 is not be able to create a virtual initiator for until a iSCSI host 215 makes itself known to gateway 101. However, generally the steps shown in FIG. 3 will occur in roughly the order and locations indicated.

The functions of an FC-iSCSI gateway 201 in accordance with the present invention can be grouped into 4 areas:
Initialization, management and configuration of the gateway itself;
Naming and Discovery of the objects by the iSCSI and FCP fabric elements and end nodes;
Creation of connections between iSCSI elements and FCP elements. In SCSI terminology, this would be the creation of an “I_T_nexus”; and
Creation of SCSI-level commands and data from the packets or frames received from either the IP or FC fabrics, mapping these to the appropriate transport of the other fabric (i.e. iSCSI or FCP) and delivery of frames or packets to the other fabric.

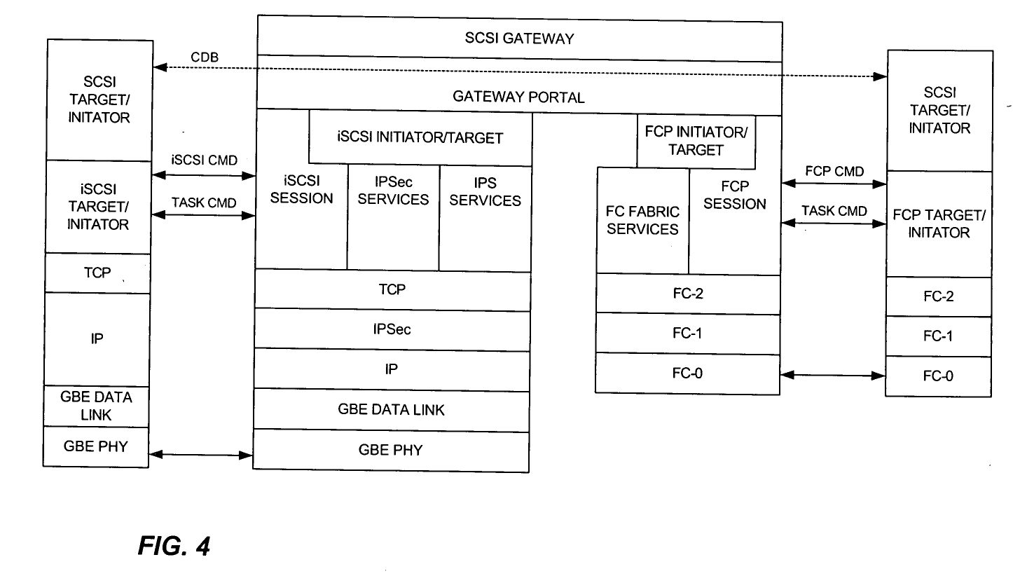

Initialization of a gateway 201 is, in many ways, a generic function of all devices and not particular to the FC-iSCSI gateway of the present invention. The functions of the three remaining areas are embodied in the “FC-iSCSI Gateway Datapath Model”. depicted in FIG. 4. The model shown in FIG. 4 describes object models for both iSCSI and FCP constructs. These constructs include links, switch elements, topologies (IP and FC_ID address maps), end nodes (MAC addresses, WWPNs, WWNN etc.), clients and servers (SCSI initiators and targets) and groupings (zones, VLANs, subnets, Autonomous Regions and the like). The model also describes representation of those objects to both the iSCSI and FCP fabrics/networks and naming and discovery of the objects by the iSCSI and FCP fabric elements and end nodes.

The Gibabit Ethernet (GbE) Physical component in FIG. 4 is responsible for support of copper and optical connections and auto-negotiation. A core object of the GbE PHY module is a gbePort. The GbE Data Link component is responsible for maintaining the MAC address of the gateway, support of ARP, supporting GbE protocols (i.e. VLAN tags, DiffServ, link aggregation 802.3AD, HA and trunking protocols, stats and counters for RMON, 802.1Q and P etc.), The core object of the GbE Link Module is a gbeLink. The GbE data link component is also responsible for delivering full GbE packets to the IP layer through “packet pipes”. The GbE Data Link component may support multiple “packet pipes”, corresponding to a gateway with multiple physical links. The data link layer is also responsible for maintaining packet counts in both directions, executing link state machines, reporting link states and statistics (up, down, CRC error counts etc.) to management layers, supporting the parameters of defined management information base (MIB) objects and supporting GbE attributes such as “jumbo frames” and multicast groups.

The IP component provides support for IPv4, with multiple IP addresses per GbE port and r-assembly of IP Packets and delivering them to the TCP layer. The core object of IP module is an IPConnection. The IP component obtains and maintains the gateway's IP address(es), which may include participating in DHCP or manual configuration of IP address, default gateway, subnet mask, etc. The IP module supports UDP (for IKE), ICMP and ARP protocols, MTU discovery (e.g., RFC1191). Moreover, the IP component may implement a router module (not shown) which supports IP Packet Forwarding, IP Packet Filtering, and/or other router services. The IP module may also support “Explicit Congestion Notification and Random Early Detection as proposed in RFC2481 and the “IP Group” parameters of the management information base for the Internet Protocol using SMIv2 (i.e., RFC #2011).

The IPSec component supports connections with no security and supports IPSec mechanisms. The IPSec component handles re-keying. and reports security related statistic and errors (e.g., security attacks) as well as supporting IPSec MIBs (e.g., IPSec Flow Monitoring MIB, IKE Monitoring MIB, and the IPSec Monitoring MIB.

The TCP component is responsible for TCP flow control, congestion management, connection state information, and the like. The core object of TCP module is a TCPConnection. The TCP component handles connection establishment, the use of MTU discovery of an IP module per session, and performs TCP packet retransmission, segmentation and reassembly. The TCP module also maintains bandwidth usage statistics and enforces bandwidth provisioning if any. The TCP component also supports TCP Group parameters as defined in the MIB described by RFC 1213 and RFC2012, as well as supporting functionality described in RFC2018, RFC2581, RFC1110, RFC1323, RFC2582, and RFC2883 as well as any other desired TCP functionality desired for a particular application.

The iSCSI Session module enables delivery of iSCSI PDUs to an iSCSI virtual device and maintaining Portal Groups, as well as iSCSI login, authentication, and logout process. The core objects of the iSCSI Session module are iSCSISessions, discoverySessions and ipFabricSessions. The iSCSI session module maintains ISCSI session and individual connection transitions and iSCSI Session State transitions. The session module also implements iSCSI Access Control Lists (ACLs) and maintains a “discoverySession” object to respond to iSCSI Discovery Session commands (such as SendTargets etc.). The iSCSI session component also negotiates and maintains necessary operational parameters for the current session (such as immediate data, unsolicited data, maximum PDU length, maximum number of connections, recovery level). The iSCSI session component also maintains the session resources, and ensures correct and updated command, status, and data sequences. ISCSI provides session level recovery and supports the iscsiTargetPortal and iscsiInitiator Portal parameters of the MIB defined in the “Definition of Managed Objects for iSCSI”, Bakke et al., IPS Internet Draft, Version 0.2, November 2001.

The IPS Services module supports discovery protocols (i.e. SLP SA, SLP UA registration with DA, iSNS client registration etc.). The IPSec services module maintains security profiles for gateway portals, sessions and Gateway Portal Groups. Other functionality in the IPSec services component includes support for pre-shared keys through secure interface, support for key management services, including key exchange via IKE, maintenance of security association for connections and maintenance of security profiles, keys, etc., for network management modules.

In a particular implementation, a configuration process implemented by the gateway initiates the creation of GatewayPortalGroups and GatewayPortals. The GatewayPortals are moved to the “configured” state. A discovery process operates to identify iSCSI initiator names and its EUI format name and to use its equivalent WWNN and WWPN to log into the FC fabric services on behalf of the iSCSI initiator.

The discovery process begins with the discovery of targets devices. Thus, in the case of FC targets, the process begins when an iSCSI Initiator opens a “Discovery iSCSI Session”, causing the creation of a discoverySession object in the iSCSI Session Module. The discoverySession object asks the SCSI Gateway Module for a mapping of the iSCSI Initiator to a GatewayPortalGroup. This causes the assignment of a WWNN and a WWPN to the GatewayPortalGroup. Once the WWNs are established, the associated GatewayPortalGroup then requests the creation of an fcpvinitiator (or a number of fcpvinitiators if multiple TCP connections per iSCSI session is supported). Once a GatewayPortalGroup has a WWPN (and perhaps a WWNN if it is a gWWNN), this mapping should be maintained in a non-volatile store until it is changed by manual configuration. Note also that it may be necessary to allow a user to enter an arbitrary WWN in order to account for things such as multiple paths or Fibre Channel authentication.

It is possible that an initiator may simply log on to the gateway without performing discoverySession first. When this happens, gateway 201 is still able to obtain the initiator's iSCSI name, and its 64-bit EUI format name, and thus able to assign a WWNN and a WWPN to the GatewayPortalGroup and accept the login request once FC Targets are discovered.

Each fcpvinitiator opens a first fcFabricSession with the FC Login Server and a second fcFabricSession FC Name Server. The fcpvinitiator then makes a Name Server query to discover the appropriate FC targets. The fcpvInitiator then creates an fcpSession with each target and performs a port log in (PLOGI) with the target device. The result is returned to the GatewayPortalGroup. Each fcpSession, if successful, notifies its GatewayPortal, which moves the GatewayPortal to state indicating that the port is logged on (i.e., at LogDone state). The Gateway Portal may also apply its own access control at this point and create an appropriate iSCSIvTarget. Each iSCSIvTarget will create a TCPConnection and the TCP module will return a TCP port number for that connection. The gateway portal will now have the fcpvinitiator(s) and the iSCSIvTarget, and be in the “tLogDone” state.

When an iSCSI Initiator sends a SendTargets command to the discoverySession. object, the discoverySession queries the GatewayPortalGroup for the iSCSIvTargets of all GatewayPortals in the tLogDone state and creates an iSCSIvTarget list. This iSCSIvTarget list is sent as the response to the SendTargets command. When the iSCSI Initiator opens an iSCSISession with an iSCSIvTarget and logs in, the iSCSIvTarget's GatewayPortal will be in the “loginDone” state.

Gateway Portal Groups are used to group all the targets seen by a single initiator into one group. This grouping is referred to as a Common Initiator Gateway Portal Group and denoted GPGi, or Common Target Gateway Portal Group to group all the initiators seen by a single target (denoted a GPGt). Another grouping contemplated is to group multiple initiators and targets to correspond with an FC zone or an iSCSI Discovery Domain. This grouping may be useful for management and configuration of access controls and is termed GPGm.

To facilitate the several uses of a GPG, “wild card” expressions may be used in the Initiator or Target field of a GPG. A GPGi has only a wild card for a target and will automatically create GPs for any and all targets it finds in the discovery process as the initiator. A GPGt has a wild card for an initiator and will register the target for automatic discovery and create a GP upon a login request from any initiator. Finally, a GPG with 2 wild cards (i.e. {*, *}) is termed the “permissive GPG” (denoted GPGp) and allows minimal configuration. A gateway 201 can be configured to have a permissive GPG upon power-up to allow “plug-and-play” (PnP) operation. In a PnP mode, gateway 201 queries both fabrics for any initiators it sees, creates a GPGi for each initiator and the corresponding GPs and virtual targets are created automatically. The use of wildcards in Gateway Portal Groups can lead to duplicate registrations of a single device. Preferably, a gateway 201 includes processes to avoid this condition and/or detect and correct the condition should it exist.

A Gateway Portal Group can be described by its defined states and state transitions. A GPG is initialized at RESET state and moves up to CONFIGURED state after it has loaded configuration necessary. When the configuration of the Gateway Portal Group is invalid, it will move to ERROR state until being reconfigured. Gateway Portals are created in a CONFIGURED state. The Gateway Portal Group is in an ACTIVE state when at least one Gateway Port member is created and has active sessions. While in ACTIVE state, more Gateway Portals may be created, and may have sessions operational. Some Gateway Portals may also become inactive and deleted from the Gateway Portal Group (because their respective initiators and targets no longer join the fabrics). Modification to the Gateway Portal Group configuration will immediately cause GPG to go to CONFIGURED state. An ACTIVE Gateway Portal may be brought down an brought up with the new configuration information if necessary. The FC-iSCSI gateway may boot up with no configuration for Gateway Portal Groups. In this case, one Gateway Portal Group is created and enters DISCOVERY state. The GPG will advertise its WWN and iSCSI names and join the discovery process in both FC and IP fabrics.

In operation, each iSCSI node has a unique iSCSI name. The iSCSI name is mapped to a WWN in the FC fabric. Gateway 201 creates a virtual FC node (initiator or target) for this iSCSI node, and use the mapped WWN to log on to FC Naming and zoning services. Conversely, each FC node with a unique WWN is mapped to an iSCSI node. The gateway creates a virtual iSCSI node (initiator or target) and use this iSCSI name to participate in iSCSI fabric operations such as SLP, or iSNS discovery services and send targets operations. To be accessible and to participate in the fabric discovery process, each virtual initiator/target has at least an associated unique WWPN or one IP address plus a listening TCP port number. Gateway 201 assigns these numbers from a pool of preprogrammed addresses in NVRAM at manufacturing time in a conventional manner.

In iSCSI fabric, the initiator conveys its iSCSI name and gives an initiator session ID (ISSID) while logging into the target. The initiator accesses a target through the target's allowed network portal(s). The session of iSCSI initiator and the target defines an I_T nexus. The I_T nexus is identified by the tuple of iSCSI Initiator Name+‘i’+ISID, iSCSI Target Name+‘t’+Portal Group Tag. For a virtual iSCSI target/initiator, there may be more than one iSCSI sessions (as in one initiator connecting to more than one target or one target to more than one initiator). For unique identification of a session, the virtual target/initiator uses a pair of identifiers of ISID and TSID. In FC fabric, an I_T nexus can be identified as a FCP session between two WWPNs, one of the initiator and one of the target. A destination identifier (D_ID) is sufficient to identify the end point of the session.

Both FCP and iSCSI are SCSI transports that are compliant with SCSI requirements. Table 1 lists the types of messages that can be directly through the Gateway:

TABLE 1

| | |
|---|---|
| iSCSI | FCP |
| Command | FCP_CMND |
| Task Management | FCP_CMND |
| Data-In | FCP_DATA |
| Data-Out | FCP_DATA |
| R2T | FCP_XFER_RDY |
| Response | FCP_RSP |

Therefore, once an I_T nexus is established across gateway 201, SCSI messages will be passed through gateway 201 without little additional processing by gateway 201. In other words, once configured, gateway 201 is essentially transparent to the end nodes in their communication.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A gateway comprising:
a first port coupled to a first network;
a second port coupled to a second network;
processes implemented within the gateway for identifying at least one service provided by the first network that is not provided by the second network; and
processes implemented within the gateway for implementing the at least one service on behalf of the second network.

2. The gateway of claim 1 further comprising processes implemented within the gateway for determining when the at least one service is implemented in the second network; and
processes implemented within the gateway for ceasing the provision of the at least one service in favor of allowing the second network to provide the at least one service.

3. The gateway of claim 1 wherein at least one of the first and second networks comprises a Fibre Channel network.

4. The gateway of claim 1 wherein at least one of the first and second networks comprises an Internet Protocol network.

5. The gateway of claim 1 wherein at least one of the first and second networks comprises a storage area network (SAN).

6. The gateway of claim 1 wherein the at least one service provided by the first network is a naming service and the processes implemented within the gateway comprise a naming service implemented on behalf of the second network.

7. The gateway of claim 1 wherein the at least one service provided by the first network comprises a discovery service and the processes implemented within the gateway comprise a discovery service implemented on behalf of the second network.

8. The gateway of claim 1 wherein the at least one service provided by the first network is a zoning service and the processes implemented within the gateway comprise zoning service implemented on behalf of the second network.

9. The gateway of claim 1 wherein the at least one service provided by the first network is security service and the processes implemented within the gateway comprise a security service implemented on behalf of the second network.

10. A method for configuring a heterogeneous network comprising:
providing a gateway having a first port coupled to a first network and a second port coupled to a second network;
identifying at least one service provided by the first network that is not provided by the second network; and
implementing the at least one service in the gateway on behalf of the second network while the second network is unable to implement that service.

11. The method of claim 10 further comprising:
determining when the at least one service is implemented in the second network; and
ceasing the implementation of the at least one service in the gateway in favor of allowing the second network to provide the at least one service.

12. The method of claim 10 wherein at least one of the first and second networks comprises a Fibre Channel network.

13. The method of claim 10 wherein at least one of the first and second networks comprises an Internet Protocol network.

14. The method of claim 10 wherein at least one of the first and second networks comprises a storage area network (SAN).

15. The method of claim 10 wherein the at least one service provided by the first network is a naming service and the act of implementing the at least one service in the gateway comprises implementing a naming service implemented on behalf of the second network.

16. The method of claim 10 wherein the at least one service provided by the first network comprises a discovery service the act of implementing the at least one service in the gateway comprises implementing a discovery service on behalf of the second network.

17. The method of claim 10 wherein the at least one service provided by the first network is a zoning service the act of implementing the at least one service in the gateway comprises implementing a zoning service on behalf of the second network.

18. The gateway of claim 10 wherein the at least one service provided by the first network is security service a the act of implementing the at least one service in the gateway comprises implementing a security service on behalf of the second network.

19. A gateway for joining disparate networks, the gateway comprising:
a first port coupled to a first network;
a second port coupled to a second network;
processes in communication with the first port and the second port for identifying at least one device on each of the incompatible networks;
processes in communication with the first port and the second port for creating a virtual representation of each of the identified devices
a connection between each virtual representation and the at least one identified device that is being represented; and
a connection between the virtual representations to implement a functional connection between the identified devices.
